(19) United States
(12) Patent Application Publication
(10) Pub. No.: US 2025/0123890 A1
(43) Pub. Date: Apr. 17, 2025

(54) BROWSER-BASED APPLICATION PERFORMANCE BY PRIORITIZING KEY CONTENT OVER ADVERTISING CONTENT

(71) Applicant: DELL PRODUCTS L.P., Round Rock, TX (US)

(72) Inventors: Mitchell Markow, Hutto, TX (US); Farzad Khosrowpour, Pflugerville, TX (US)

(21) Appl. No.: 18/488,797

(22) Filed: Oct. 17, 2023

(51) Int. Cl. G06F 9/50

(52) U.S. Cl. CPC G06F 9/5027

(57) ABSTRACT

An information handling system includes processing hardware, a web browser, a hardware scheduler, and a browser inference module. The web browser retrieves a webpage including content and an advertisement, and provides browser process information related to the processes launched by the web browser for the content and the advertisement. The hardware scheduler directs the execution of processes on the processing hardware. The browser inference module receives the browser process information, and provides an indication to the hardware scheduler to prioritize first processes associated with the content over second processes associated with the advertisement based upon the browser process information.

### FIELD OF THE DISCLOSURE

This disclosure generally relates to information handling systems, and more particularly relates to improving browser-based application performance by prioritizing key content over advertising content in an information handling systems.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include processing hardware, a web browser, a hardware scheduler, and a browser inference module. The web browser may retrieves a webpage including content and an advertisement, and provide browser process information related to the processes launched by the web browser for the content and the advertisement. The hardware scheduler may direct the execution of processes on the processing hardware. The browser inference module may receive the browser process information, and provide an indication to the hardware scheduler to prioritize first processes associated with the content over second processes associated with the advertisement based upon the browser process information.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an information handling system according to an embodiment of the current disclosure;

FIG. 2 is a block diagram of a machine learning (ML) system according to an embodiment of the current disclosure; and

FIG. 3 is a block diagram illustrating a generalized information handling system according to another embodiment of the present disclosure;

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

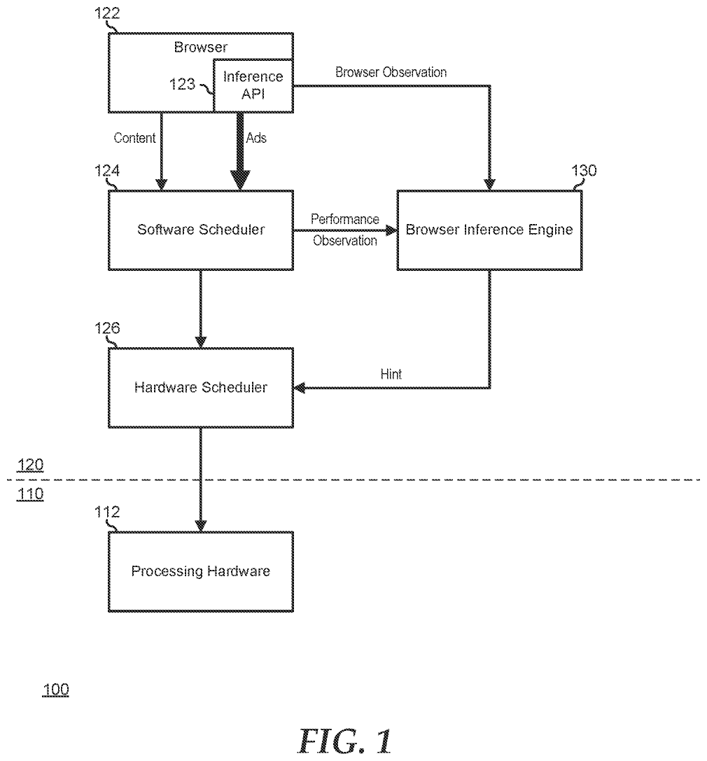

FIG. 1 illustrates an information handling system 100 including system hardware 110 and a host processing environment 120. System hardware 110 includes processing hardware 112 which represents hardware devices that are provided on information handling system 100 to instantiate host processing environment 120, and the host processing environment implements the functions and features normally associated with the processing tasks to which information handing system 100 is dedicated. In particular, host processing environment 120 may include a basic input/output system/universal extensible firmware interface (BIOS/UEFI) that loads an operating system (OS) to provide a hosted environment to launch programs, applications, utilities, or the like. Processing hardware 112 includes various processing devices, such as one or more general purpose processor (CPU), one or more graphics processor (GPU), one or more processing accelerator (referred to generally as “XPU”), or other processing devices, as needed or desired. Processing hardware 112 may further include various I/O controller hubs, system memory devices, non-volatile memory devices, storage devices, human interface devices, network interface devices, or the like, as needed or desired. The functions and features of processing hardware and a host processing environment, including the instantiation of a BIOS/UEFI on hardware devices, the loading of an (OS), and the launching of programs, applications, and utilities, is known in the art and will not be further described herein, except as may be needed to illustrate the current embodiments.

Host processing environment 120 includes a browser 122, a software scheduler 124, a hardware scheduler 126, and a browser inference module 130. Browser 122 represents a user interface that is tailored to access and view websites on the Internet, within a corporate internet, or the like. In particular, when a user of information handling system 100 enters a desired website, such as by entering a Universal Resource Locator (URL), an Internet Protocol (IP) address, or the like, into browser 122, the browser operates to retrieve data files from the website and to display a webpage associated with the data files to the user on a display device of information handling system 100. An example of browser 112 may include a Google Chrome browser or Chromium open-source browser, an Apple Safari browser, a Microsoft Edge browser, a Firefox browser, or the like.

In operation, browser 122 spawns multiple processes on processing hardware 112 to access the website, to download and store the data files, to display the webpage, and to perform other tasks associated with the webpage. For example, a browser 122 may utilize a browser process, a network interface process, a user interface process, a storage process, a GPU process, one or more device processes, one or more renderer process, one or more plug-in process, or other processes, as needed or desired. The code associated with the processes may be included in browser 122, or may be code that is native to host processing environment 120 that is called by the browser (that is, one or more process driver). Where browser 120 is implemented utilizing included processes, the operations of the browser, and particularly the tasks spawned by the browser, may be opaque to host processing environment 120. This may be due to the closed-source nature of the code utilized to instantiate browser 122 on host processing environment 120. On the other hand, where browse 120 utilizes native processes to host processing environment 120, or where the browser code is open-source code, the host processing environment may have greater insight into the utilization of the processes spawned by the browser. In a particular embodiment, browser 122 includes an inference application programming interface (API) 123 that operates to provide insight into the processes spawned by the browser, as described further below.

Software scheduler 124 represents a service or utility instantiated in host processing environment 120 that operates to evaluate the requested processes on information handling system 100, and to determine an order in which the processes are scheduled for execution. Software scheduler 124 typically employs a priority scheme that assigns a priority to each process, and evaluates the prioritized processes based upon a scheduling algorithm to schedule the processes. The scheduling algorithm typically ensures that higher priority processes, such as real-time processes, are scheduled for execution before lower prior to lower priority processes, such as background processes. Software scheduler 124 receives the process requests from browser 122 and schedules the received processes. In a typical case, software scheduler 124 is provided as a service or utility associated with an OS instantiated on host processing environment 120. An example of software scheduler 124 may include a Microsoft Scheduler, a Linux schedular, or the like.

Hardware scheduler 126 represents a service or utility instantiated in host processing environment 120 that operates to evaluate the scheduled processes from software scheduler 124, and t determine which processes are to be executed on the various elements of processing hardware 112. In particular, hardware scheduler 126 operates to schedule the processes on the appropriate processors, and, within the context of multi-core CPUs with dedicated efficiency cores and performance cores, to schedule the processes on the appropriate cores. For example, hardware scheduler 126 may be given indications as to whether a process is a compute intensive process, a video intensive process, or the like, and can then schedule compute intensive processes on a particular core of a CPU and video intensive processes on a GPU, as needed or desired. Hardware scheduler 126 may represent a service or utility associated with the OS instantiated on host processing environment 120, with a processor family, such as an Intel Hardware Guided Scheduling+ (HGS+) or the like, or with a combination thereof.

It has been understood by the inventors of the current disclosure that an increasing amount of the activity on an information handling system is conducted on the Internet, corporate internets, edge-based and cloud-based network systems, backend services, and the like, and that such activity is based on the use of web browsers to access the remote resources and services. In particular, remote meeting applications, remote workspaces such as remote- or virtual-desktops, virtual private networks, cloud- and edge-based distributed processing, and the like, are increasingly conducted through web browser interfaces, rather than through stand-alone applications. It has been further understood that the data files served up by many websites include a large amount of advertisements or other non-core functions and features, as compared with a relatively small amount of desired content. This is certainly true of generally accessible webpages served up on the Internet. However, it is increasingly true that Internet-based services that are bought and paid for often include a large amount of advertisements in addition to the purchased services. This barrage of advertisements often overwhelms the desired content, slowing the performance of the information handling system to perform the desired tasks or to view the desired content, and threatens to negate the benefits of the distributed compute environment.

Browser inference module 130 represents a machine learning (ML) engine configured to observe telemetry from browser 122 and from software scheduler 124, and to provide hints to hardware scheduler 126 to effectively prioritize the processes associated with the content while deprioritizing the processes associated with the advertisements. As such, browser inference module 130 provides an inference model that is trained on the differences between content and advertisements, as indicated by browser 122 and by software scheduler 124.

As noted, browser 122 may be an open-source browser or a closed-source browser, as needed or desired. When browser 122 is an open-source browser, such as the Google Chromium open-source browser, inference API 123 may be designed to monitor the activities of the browser in executing the various processes, such as a number of workers associated with each webpage and the tasks associated with each worker (whether the worker is associated with content or advertisements, etc.), a number of threads per worker, the presence on the webpage of plug-ins and the use of the plug-ins (streaming content plug-ins versus streaming ad plug-ins, etc.), the loading speed, or the like. However, even when browser 122 is a closed-source browser, the provider of the browser may typically provide various web developer tools and performance tracking tools that permit the exportation of select information related to the browser's process execution activities, including information related to whether a particular process is related to the content or to the advertisements. In either case, inference API 123 provides the information related to content and ad processes to browser inference module 130 for analysis. The details of web browser architecture, and particularly of data reporting from a web browser, are known in the art and will not be further described herein, except as may be needed to illustrate the current embodiments.

Software scheduler 124 provides further information to browser inference module 130 related to the scheduling of the processes from browser 122. Software scheduler 124 provides the information for the content and for the advertisements in order to characterize the resource utilization of processing hardware 112, including CPU, GPU, and network per process.

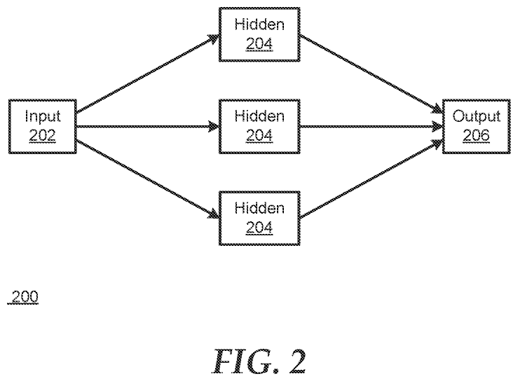

FIG. 2 illustrates a machine learning system 200 according to at least one embodiment of the disclosure. Machine learning system 200 includes an input layer 202, one or more hidden layers 204, and an output layer 206. Machine learning system 200 may be substantially similar to browser inference module 130 of FIG. 1. Input layer 202 may receive any suitable data associated with an information handling system, such as information handling systems 100 of FIG. 1, and provide the data to hidden layers 204. In an example, the browser information from browser 122 and scheduling information from software scheduler 124, and the processes associated therewith, may be utilized as an input data to input layer 202 of machine learning system 200. Hidden layers 204 may perform one or more operations on the browser information and the software scheduler information and determine a correlation between the input information and the processes associated therewith, and particularly with whether the processes correlate to content or ads. During training of machine learning system 200, both sets of input data may be utilized to correlate the processes with the content and the ads. During supervisory training, content and ads may be matched with the input information for a corresponding information handling system. Based on the training, hidden layers 204 may provide a hint to hardware scheduler 126 on output layer 206.

In an example, the training of hidden layers 204 may be performed in any suitable manner including, but not limited to, supervised learning, unsupervised learning, reinforcement learning, and self-learning. In an example, any machine learning model may be utilized for determining a user experience including, but not limited to, a linear regression model. During execution of machine learning system 200, input layer 202 may receive the input information and provide the input information to hidden layers 204 in any suitable manner. For example, input layer 202 may convert the input information into corresponding scaled values, may provide the input information as received, or the like. Hidden layers 204 may then apply the received input information to the training data, which may provide a hint to hardware scheduler 126 via output layer 206. An example of a ML algorithm may include a linear regression algorithm, a logistic regression algorithm, a decision tree algorithm, a support vector machine (SVM) algorithm, a naïve Bayes algorithm, a K-nearest neighbor (KNN) algorithm, a K-means algorithm, a random forest algorithm, a dimensionality reduction algorithm, a gradient boosting algorithm, or the like.

The hints provided by browser inference engine 130 may be related to other types of activities or processes provided by browser 122. For example, the observation information may relate to more than just content and advertisements, including information related to streaming applications, website banners, or other types of processes, as needed or desired. The hints may further be provided with respect to various operating modes implemented on information handling system 100, such as power modes, battery modes, performance modes, or the like. Thus, when information handling system 100 is in a performance mode, the hints may direct hardware scheduler 126 to direct processes associated with content to performance cores (P-cores) of processing hardware 112, while relegating advertisement processes to efficiency cores (E-cores). On the other hand, when information handling system 100 is operating in a low-power mode (a green mode), the hints may direct hardware scheduler 126 to delay the scheduling of advertisement content until the E-cores are available to execute the advertisement processes.

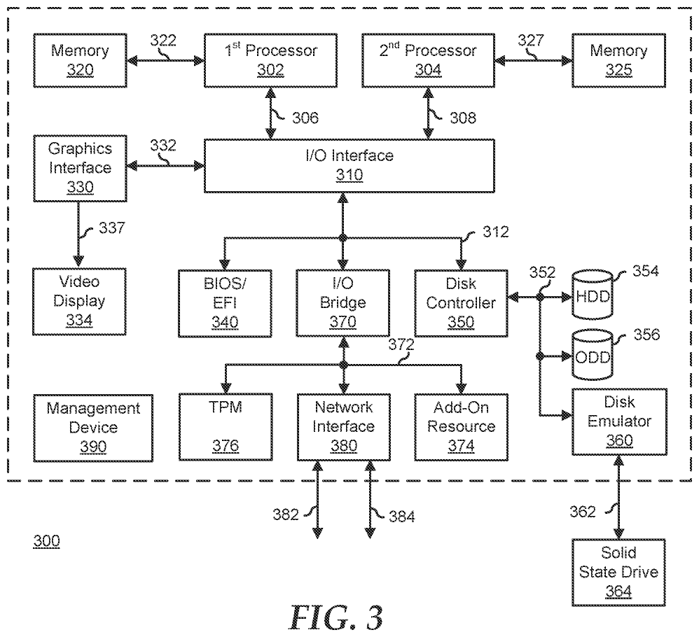

FIG. 3 illustrates a generalized embodiment of an information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 364, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 364, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 325 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 2394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
processing hardware;
a web browser configured to retrieve a webpage including content and an advertisement, and to provide browser process information related to the processes launched by the web browser for the content and the advertisement;
a hardware scheduler configured to direct the execution of processes on the processing hardware; and
a browser inference module configured to receive the browser process information, and to provide a first indication to the hardware scheduler to prioritize first processes associated with the content over second processes associated with the advertisement based upon the browser process information.

2. The information handling system of claim 1, further comprising:
a software scheduler configured to schedule the execution of processes on the processing hardware, and to provide schedule process information related to the processes launched by the web browser;
wherein the browser inference engine is further configured to receive the schedule process information, and wherein the first indication is further based upon the scheduler process information.

3. The information handling system of claim 2, wherein the browser inference engine utilizes a machine learning algorithm utilizing the browser process information and the software process information as inputs and providing the first indication as an output.

4. The information handling system of claim 3, wherein the machine learning algorithm includes at least one of a linear regression algorithm, a logistic regression algorithm, a decision tree algorithm, a support vector machine algorithm, a naïve Bayes algorithm, a K-nearest neighbor algorithm, a K-means algorithm, a random forest algorithm, a dimensionality reduction algorithm, and a gradient boosting algorithm.

5. The information handling system of claim 1, wherein the process information includes a number of browser workers associated with the content and with the advertisement.

6. The information handling system of claim 5, wherein the process information includes a number of threads associated with each browser worker.

7. The information handling system of claim 1, wherein the process information includes a second indication that the webpage includes a plug-in.

8. The information handling system of claim 7, wherein the second indication further identifies that the plug-in is associated with the content.

9. The information handling system of claim 7, wherein the second indication further identifies that the plug-in is associated with the advertisement.

10. The information handling system of claim 1, wherein the process information includes a loading speed of the webpage.

11. A method, comprising:
providing, on an information handling system, processing hardware;
providing, on the information handling system, a web browser configured to retrieve a webpage including content and an advertisement;
providing, by the web browser, browser process information related to the processes launched by the web browser for the content and the advertisement;
providing, on the information handling system, a hardware scheduler configured to direct the execution of processes on the processing hardware;
providing, on the information handling system, a browser inference module;
receiving, by the browser inference module, the browser process information; and
providing, by the browser inference module, a first indication to the hardware scheduler to prioritize first processes associated with the content over second processes associated with the advertisement based upon the browser process information.

12. The method of claim 11, further comprising:
providing, on the information handling system, a software scheduler configured to schedule the execution of processes on the processing hardware;
providing, by the software scheduler, schedule process information related to the processes launched by the web browser; and
receiving, by the browser inference engine, the schedule process information, wherein the first indication is further based upon the scheduler process information.

13. The method of claim 12, wherein the browser inference engine utilizes a machine learning algorithm utilizing the browser process information and the software process information as inputs and providing the first indication as an output.

14. The method of claim 11, wherein the process information includes a number of browser workers associated with the content and with the advertisement.

15. The method of claim 14, wherein the process information includes a number of threads associated with each browser worker.

16. The method of claim 11, wherein the process information includes a second indication that the webpage includes a plug-in.

17. The method of claim 16, wherein the second indication further identifies that the plug-in is associated with the content.

18. The method of claim 16, wherein the second indication further identifies that the plug-in is associated with the advertisement.

19. The method of claim 11, wherein the process information includes a loading speed of the webpage.

20. An information handling system, comprising:
processing hardware;
a web browser configured to retrieve a webpage including content and an advertisement, the web browser including an inference application programming interface configured to provide browser process information related to the processes launched by the web browser for the content and the advertisement;
a hardware scheduler configured to direct the execution of processes on the processing hardware; and
a browser inference module configured to receive the browser process information, and to provide a first indication to the hardware scheduler to prioritize first processes associated with the content over second processes associated with the advertisement based upon the browser process information.
